(19) United States
(12) Patent Application Publication
(10) Pub. No.: US 2009/0217819 A1
(43) Pub. Date: Sep. 3, 2009

(54) GAS SEPARATION MEMBRANES COMPRISING PERMEABILITY ENHANCING ADDITIVES

(76) Inventors: Matthias Wessling, Enschede (NL); Dana Manuela Sterescu, Tilburg (NL); Dimitrios Stamatialis, Enschede (NL)

Correspondence Address: FOLEY AND LARDNER LLP;SUITE 500, 3000 K STREET NW, WASHINGTON, DC, 20007, US

(21) Appl. No.: 12/282,816

(22) PCT Filed: Mar. 14, 2007
(86) PCT No.: PCT/NL07/50103

§ 371 Date: Nov. 18, 2008

(30) Foreign Application Priority Data
Mar. 15, 2006 (EP) 06111192.8

(51) Int. Cl. B01D 71/06

(52) U.S. Cl. 96/14

(57) ABSTRACT

The present invention relates to polymer compositions comprising a (co)polymer comprising (a) an arylene oxide moiety and (b) a dendritic (co)polymer, a hyperbranched (co)polymer or a mixture thereof, and the use of these polymer compositions as membrane materials for the separation of gases. The present invention further relates to the use of a dendritic (co)polymer, a hyperbranched (co)polymer or a mixture thereof as permeability and/or selectivity enhancing additives in gas separation membranes. The dendritic (co)polymer is preferably a Boltorn polymer.

### FIELD OF THE INVENTION

The present invention relates to polymer compositions comprising a (co)polymer comprising (a) an arylene oxide moiety and (b) a dendritic (co)polymer, a hyperbranched (co)polymer or a mixture thereof, and the use of these polymer compositions as membrane materials for the separation of gases. The present invention further relates to the use of a dendritic (co)polymer, a hyperbranched (co)polymer or a mixture thereof as permeability and/or selectivity enhancing additives in gas separation membranes.

### BACKGROUND OF THE INVENTION

Permeable membranes that are capable of separating a gaseous component from a fluid mixture, either gaseous or liquid, are considered in the art as a convenient, potentially highly advantageous means for achieving desirable fluid separation and/or concentration. To achieve a selective separation, the membrane must exhibit less resistance to the transport of one or more components than that of at least one other component of the mixture. in order for selective separation of one or more desired components by the use of separation membranes to be commercially attractive, the membranes must not only be capable of withstanding the conditions to which they may be subjected during the separation operation, but they also must also provide an adequately selective separation of the one or more desired components and a sufficiently high flux, i.e. the permeation rate of the permeate per unit surface area, so that the use of the separation procedure is carried out on an economically attractive basis.

Membranes have been manufactured in various shapes, e.g. flat sheets which may be supported in a typical plate and frame structure, flat sheets that are rolled into spirals together with appropriate spacing materials to provide spiraling channels permitting the passage of feed on one side of the coiled membrane to the opposite side of the membrane, hollow fibres and the like.

Various types of permeable membranes have been proposed in the art for carrying out a variety of fluid separation operations. Isotropic and asymmetric type membranes for instance are comprised essentially of a single permeable membrane material capable of selectively separating desired components of a fluid mixture. Isotropic membranes have the same density throughout the thickness thereof. Such membranes generally have the disadvantage of low permeability due to the relatively high membrane thickness. Asymmetric membranes have two distinct morphological regions within the membrane structure. One region comprises a thin, dense semi-permeable skin capable of selectively permeating one component of a fluid mixture. The other region comprises a less dense, porous, non-selective support region that serves to preclude the collapse of the thin skin region of the membrane during operation. Composite membranes generally comprise a thin layer or coating of a suitable permeable membrane material superimposed on a porous substrate. The separation layer is advantageously very thin so as to provide a high permeability. The substrate only serves to provide a support for the thin membrane layer positioned thereon and has substantially no separation characteristics. Reference is made to R. W. Baker, Ind. Eng. Chem. Res. 41, 1393-1411, 2002).

An important feature of polymeric membrane separation of gases is that high permeability (or high flux) is usually accompanied by a low selectivity and vice versa which is also known as the upper bound relationship or “trade off” relationship of binary gas mixtures (L. M. Robeson, J. Memb. Sci. 62, 165, 1991). Consequently, it would be highly desirable to improve the permeability of a membrane without a deterioration of the selectivity.

Poly(phenylene oxide) has already for a long period of time been considered important as a gas separation material, in particular due to its good gas permeation properties, physical properties, and commercial availability. For example, U.S. Pat. No. 3,350,844 discloses the use of dense poly(phenylene oxide) membranes for gas separations. However, dense membranes suffer from low gas permeation rates as the gas permeation rate is inversely proportional to the thickness of the dense gas separating layer as is well known in the art.

This disadvantage was partially overcome in the prior art through the manufacture of asymmetric poly(phenylene oxide) gas separation membranes as is disclosed in for example U.S. Pat. No. 3,709,774, U.S. Pat. No. 3,762,136, U.S. Pat. No. 3,852,388 and U.S. Pat. No. 3,980,456. Decreasing the layer thickness of the separating skin-layer is non-trivial, but required in order to maximize productivity (trans-membrane flux). U.S. Pat. No. 5,129,920 discloses a particular means to reduce skin thickness with remaining integrity of the separation performance.

U.S. Pat. No. 4,230,463 discloses multicomponent gas membranes comprising a porous separation membrane comprising e.g. a poly(phenylene oxide) and a coating which is in contact with the porous separation membrane, wherein the separating properties are in principle determined by the porous membrane. However, such membranes suffer from the disadvantage that they may have a poor environmental resistance, e.g. against acidic gases.

The use of poly(phenylene oxide) and similar polymers as gas separation membranes is well known in the art. Reference is for example made to U.S. Pat. No. 3,350,844, U.S. Pat. No. 3,709,774, U.S. Pat. No. 3,762,136, U.S. Pat. No. 3,852,388 and U.S. Pat. No. 3,735,559.

Environmentally resistant separation membranes based on cross-linked poly(phenylene oxide) are disclosed in e.g. U.S. Pat. No. 4,652,283 and U.S. Pat. No. 5,151,182.

Other methods to improve the performance of polymeric gas separation membranes are to include or to incorporate additives. For example, Ruiz-Trevino and Paul (J. Appl. Polym. Sci. 68, 403-415, 1998) disclose the incorporation of an alkylated naphthalene oligomer (known commercially as Kenflex A from Kenrich Petrochemical, Inc., Bayonne, N.J., USA) in polymeric membranes to improve the selectivity-permeability balance of the membrane. The effect of the low-molecular weight additive follows the traditionally observed trade-off between selectivity and permeability

US 2004/0177753 (cf. also Y. Xiao, T-S. Chung, M. L. Chng, Langmuir 20, 8230-8238, 2004) discloses a process wherein a polyimide is treated with for example a dendrimer, wherein the dendrimer cross-links the polyimide. The dendrimer may be a polypropyleneimine dendrimer up to generation four and having primary amino groups. It appears that increased cross-linking provides higher selectivity, but that permeability decreases.

WO 99/40996 discloses an asymmetric composite membrane having at least three layers, wherein each consecutive layer has a larger pore size than the preceding layer and wherein the layer having the smallest pores is impregnated with an ordered macromolecular structure, e.g. a dendrimer. Example 13 discloses a membrane of polyimide impregnated with a polysiloxane having terminal hydroxy groups which according ton Example 15 can be used to separate oxygen from air.

Increasing the productivity of a membrane is an important industrial challenge. WO 02/43937 discloses a method of shaping a hollow fibre to increase the effective surface area of a fibre with the aim to increase the productivity. The proof of such a method as increasing the productivity is reported by Nijdam et al. in J. Memb. Sci., 256, 209-215, 2005. The authors report a productivity improvement of 20%. It is obvious to the person skilled in the art that a much more dramatic increase in productivity is desired.

Consequently, there is still a need in the art to provide polymeric membranes having an improved permeability without a deteriorated selectivity or vice versa. It has now surprisingly be found that polymeric compositions of arylene oxide polymers and dendrimeric (co)polymers, hyperbranched (co)polymers and mixtures thereof, in particular compositions comprising a relatively low amount of the dendrimeric (co)polymer, the hyperbranched (co)polymer or a mixture thereof, have a very high permeability in comparison with neat arylene oxide polymer at a similar selectivity.

### SUMMARY OF THE INVENTION

The present invention therefore relates to a polymer composition comprising (a) a (co)polymer comprising an arylene oxide moiety and (b) a dendritic (co)polymer, a hyperbranched (co)polymer or a mixture thereof. The present invention also relates to a process for the preparation of the polymer composition and the use thereof in a membrane, in particular a gas separation membrane. The present invention further relates to the use of a dendritic (co)polymer, a hyperbranched (co)polymer or a mixture thereof as permeability and/or selectivity enhancing additives in gas separation membranes.

### DETAILED DESCRIPTION OF THE INVENTION

### Component (a)

According to the present invention, the (co)polymer comprising an arylene oxide moiety is preferably a polyarylene oxide, more preferably a polyphenylene oxide. Preferably, the (co)polymer comprising the arylene oxide moiety has the formula (I):

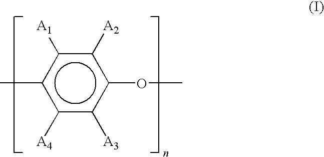

wherein A₁, A₂, A₃ and A₄ are independently selected from the group consisting of hydrogen, linear or branched C₁-C₁₂ alkyl which may optionally be halogenated, C₆-C₁₂ arylalkyl, C₆-C₁₂ alkylaryl, and halogen. Preferably, A₂ and A₃ are independently selected from the groups of linear or branched C₁-C₄ alkyl and A₁ and A₄ are independently selected from hydrogen, halogen and linear or branched C₁-C₄ alkyl.

Suitable alkyl groups are for example methyl, ethyl, 1-propyl, 2-propyl, 1-butyl and 2-butyl. Suitable arylalkyl groups are for example benzyl and 4-methylbenzyl. Suitable alkylaryl groups are for example 4-methylphenyl and 2,4-dimethylphenyl.

Most preferably, the (co)polymer comprising the arylene oxide moiety is poly(2,6-dimethyl-1,4-phenylene oxide).

Optionally, the (co)polymer comprising the arylene oxide moiety is cross-linked as is disclosed in e.g. U.S. Pat. No. 4,652,283 and U.S. Pat. No. 5,151,182, incorporated by reference for the US patent practice.

### Component (b)

Component (b) can be a dendritic (co)polymer, a (true) hyperbranched (co)polymer or a mixture thereof. It is well known in the art that dendritic (co)polymers are not always perfectly branched and may therefore have a hyperbranched structure. The degree of branching (DB) can be defined by:

$$DB = \frac{( D + T )}{( D + L + T )}$$

wherein D is the number of dendritic, L the number of linear and T the number of terminal units. Perfect dendrimers will have a DB of 1, whereas hyperbranched (co)polymers have typically a DB of 0.4 to 0.5 up to even 0.9. In this patent application, the term “dendrimer” is to be understood as including “perfectly branched dendrimers” as well as “imperfectly branched dendrimers” which are also referred to as “hyperbranched (co)polymers”. Alternatively, the term “hyperbranched (co)polymers” may also comprise “true” hyperbranched (co)polymers. That is, that these macromolecules are purposively prepared as having a hyperbranched structure. The term “dendrimer” is to be understood as comprising both dendrimeric homopolymers and dendrimeric copolymers. The term “copolymer” includes polymers made of at least two different monomers.

Preferably, if component (b) is a dendritic (co)polymer, the latter is preferably from the polyester type having terminal hydroxy groups and is derived from a central initiator molecule comprising three to six hydroxy groups and a monomeric chain extender.

More preferably, the dendritic (co)polymer is derived from a central initiator molecule having at least one reactive hydroxy group (A), which hydroxy group (A) under formation of an initial tree structure is bonded to a reactive carboxyl group (B) of a monomeric chain extender holding the two reactive groups (A) and (B), which tree structure is optionally extended and further branched from the initiator molecule by an addition of further molecules of a monomeric chain extender by means of bonding with the reactive groups (A) and (B) thereof, wherein the monomeric chain extender has at least one carboxyl group (B) and at least two hydroxy groups (A) or hydroxyalkyl substituted hydroxyl groups (A).

Examples for suitable central initiator molecules are dimethylol propane, ditrimethylene propane, pentaerythritol, glycerol and the like. More preferably, the central initiator molecule comprises four hydroxy groups.

The monomeric chain extender is preferably a monofunctional C₂-C₆ carboxylic acid having at least two hydroxy groups. Most preferably, the chain extender is 2,2-bis(hydroxymethyl)propionic acid.

Preferably, the first generation of the dentritic (co)polymer has the formula (II):

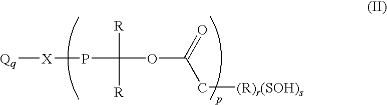

wherein X is O or C;
Q is H or linear or branched C₁-C₆ alkyl;
P is linear or branched C₁-C₆ alkylene;
R is H or linear or branched C₁-C₆ alkyl;
p+q=2 or 4;
if X is O, then q=0 and p=2;
if X is C, then p=2-4, q=0-2, and p+q=4;
S is linear or branched C₁-C₆ alkylene;
r+s=3;
r=0 or 1; and
s=2 or 3.

Suitable alkyl groups are identified above. Suitable alkylene groups include methylene, ethylene, 1,3-propylene, 1,2-propylene, 2-methyl-1,3-propylene and the like.

In a preferred class of the dendritic (co)polymers according to formula (III), q=0, X=C, and p=4.

In a more preferred class of the dendritic (co)polymers according to formula (III), q=0, X=C, p=4, r=1, and s=2.

The dendritic (co)polymer according to the present invention is obtainable by converting a central initiator molecule according to formula (III) with a monomeric chain extender according to formula (IV):

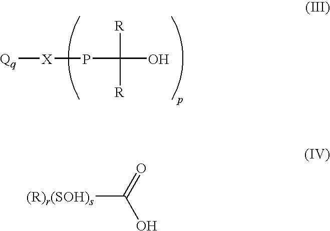

wherein P, Q, R, S, p, q, r and s are as defined above. Preferably, the conversion is performed in the presence of an acidic catalyst, e.g. a Bronsted acid or a Lewis acid.

Suitable examples of the compounds according to formula (III) are trimethylolethane, trimethylolpropane, glycerol, pentaerythritol, ditrimethylolpropane, diglycerol and ditrimethylolethane. A preferred example of the compound according to formula (III) is pentaerythritol.

Suitable examples of the compounds according to formula (IV) are α,α-bis(hydroxymethyl)propionic acid, α,α-bis(hydroxymethyl)butyric acid, α,α-bis(hydroxymethyl)valeric acid, and α,α,α-tris(hydroxymethyl)acetic acid.

A preferred example of the compound according to formula (IV) is α,α-bis(hydroxymethyl)propionic acid

Preferably, the dendritic (co)polymer according to the present invention comprises the 1^{st}-6^{th} generation, more preferably the 1^{st}-4^{th} generation.

Alternatively, if component (b) is a “true” hyperbranched (co)polymer, the latter is preferably from the polyester type having terminal hydroxy groups and is derived from a central core, at least one generation comprising a branching chain extender and optionally at least one generation comprising a spacing chain extender.

The central core is preferably selected from the group consisting of epoxide compounds having at least one reactive epoxide group and reaction products of epoxide compounds, said reaction products having at least one reactive epoxide group. The branching chain extender is preferably selected from the group consisting of branching chain extenders having at least three reactive sites, said reactive sites comprising (i) at least one hydroxy group or a hydroxyalkyl substituted hydroxy group and at least a carboxy group, or (ii) at least one hydroxy group or a hydroxyalkyl substituted hydroxy group and at least a terminal epoxide group. The spacing chain extender is preferably selected from the group consisting of spacing chain extenders having at least two reactive groups, wherein one reactive group is a hydroxy group or a hydroxyalkyl substituted hydroxy group and one reactive group is a carboxy group or an epoxide group.

More preferably, the “true” hyperbranched (co)polymer comprises a central nucleus reacted with at least one generation of a monomeric or polymeric branching chain extender and optionally at least one generation of a monomeric or polymeric spacing chain extender, wherein:
(a) the central nucleus prior to the reaction comprises a reactive epoxide group and is selected from the group consisting of:

(i) a glycidyl ester of:
(1) a saturated monofunctional carboxylic acid having 1-24 carbon atoms;
(2) an unsaturated monofunctional carboxylic acid having 3-24 carbon atoms; or;
(3) a saturated or unsaturated di-, tri- or polyfunctional carboxylic acid having 3-24 carbon atoms;

(ii) a glycidyl ether of:
(1) a saturated monofunctional alcohol having 1-24 carbon atoms;
(2) an unsaturated monofunctional alcohol having 2-24 carbon atoms;
(3) a saturated or unsaturated di-, tri- or polyfunctional alcohol having 3-24 carbon atoms;
(4) a phenol or a reaction product thereof,
(5) a condensation product between a phenol and at an aldehyde or an oligomer of such a product;

(iii) a mono-, di- or triglycidyl substituted isocyanurate; and

(iv) an aliphatic, cycloaliphatic or aromatic epoxy polymer;
(b) wherein the branching chain extender comprises three or more reactive sites, one of which being a hydroxy group or a hydroxyalkyl substituted hydroxy group and a carboxy group or terminal epoxide; and
(c) wherein the optional spacing chain extender comprises two or more reactive sites, one of which being a hydroxy group or hydroxyalkyl substituted hydroxy group.

Preferably, the hyperbranched (co)polymer according to the present invention comprises the 1^{st}-6^{th} generation, more preferably the 1^{st}-4^{th} generation.

According to the invention it is preferred that component (b) is the dendritic (co)polymer disclosed above.

Additionally, it is preferred that the dendritic (co)polymer or the hyperbranched (co)polymer has 12 to 128 hydroxy groups as functional groups. It is furthermore preferred that the M_{w} of the dendritic (co)polymer or the hyperbranched (co)polymer is in the range of 1000-10000, more preferably in the range of 1500 to 7500. Additionally, the dendritic (co)polymer or the hyperbranched (co)polymer has preferably a glass transition temperature T_{g} of 80° C. or lower, more preferably of 60° C. or lower.

Component (b) is preferably selected from the group consisting of Boltorn polymers that are manufactured by Perstorp AB, Sweden. Boltorn type polymers are disclosed in for example U.S. Pat. No. 5,418,301, incorporated by reference herein for the US patent practice. Suitable hyperbranched (co)polymers are for example disclosed in U.S. Pat. No. 5,663,247, incorporated by reference herein for the US patent practice.

### Polymer Composition

According to the invention, the polymer composition comprises preferably 0.01 to 10.0 wt. % of the dendritic (co)polymer, the hyperbranched (co)polymer or the mixture thereof, calculated on the total weight of the polymer composition. More preferably, the polymer composition comprises 0.02 to 5.0 wt. % of the dendritic (co)polymer, the hyperbranched (co)polymer or the mixture thereof.

The present invention further relates to a process for preparing a polymer composition, wherein (i) a dendritic (co)polymer, a hyperbranched (co)polymer or a mixture thereof is dispersed in (ii) a (co)polymer comprising an arylene oxide moiety. Preferably, 0.01 to 10.0 wt. % of (i) is dispersed in (ii).

The polymer composition according to the present invention is especially suitable for manufacturing membranes, in particular membranes for separating gases. The membranes according to the invention may comprise a support. Suitable supports include anisotropic porous support to provide a low resistance to permeate passage.

### EXAMPLES

### Example 1

### Preparation of PPO—Boltorn Membranes

PPO samples were prepared according to the method described in J. Smid et al., J. Membr. Sci. 64, 121, 1991. For the preparation of pure PPO membranes, the PPO was dissolved in chloroform (10 wt % polymer solution). The solution was cast on a glass plate and dried first under nitrogen atmosphere at room temperature (20°-25° C.) for 3 days and then in a vacuum oven at 50° C. under nitrogen atmosphere for 2 days.

For the preparation of PPO membranes dispersed with Boltorn (three different generations: H20, H30 and H40), the PPO and the Boltorn were dissolved separately: PPO in chloroform (10 wt % polymer solution) and the Boltorn in NMP (10 wt % Boltorn solution), respectively. The solutions were stirred at room temperature until complete dissolution of PPO and Boltorn in chloroform and NMP, respectively (for 3-4 hours). Then, the two solutions were mixed in order to get a polymer solution containing 0.05, 0.1, 0.25, 0.5, 0.75 and 1.0 wt. % Boltorn. The solutions were stirred until they became homogeneous (for 4 hours).

These PPO-dispersed Boltorn solutions were cast on a glass plate and dried under a nitrogen atmosphere at room temperature (20°-25° C.) for 3 days. After that the PPO-Boltorn films of 40-70 μm thickness were peeled off from the glass plate and dried in a vacuum oven at 30° C. until constant weight (for approximately 2 months). Table 1 presents the composition of the solutions for the membrane preparation and the estimated amounts of Boltorn in the membrane, calculated using the equation:

$$\% wt ( Boltorn \text{/} membrane ) == \frac{{g}_{Boltorn}}{{g}_{Boltorn} + {g}_{PPO}} \times 100$$

TABLE 1

| % wt. Boltorn in | % wt. |
|---|---|
| PPO-Boltorn solution | Boltorn/membrane |
| 0.05 | 0.5 |
| 0.1 | 1.0 |
| 0.25 | 2.4 |
| 0.5 | 4.8 |
| 0.75 | 7.0 |
| 1.0 | 9.1 |

For comparison, membranes were also prepared by dissolution of PPO in a mixture of chloroform/NMP, following exactly the procedure as for the preparation of PPO-Boltorn membranes, without the addition of Boltorn.

### Example 2

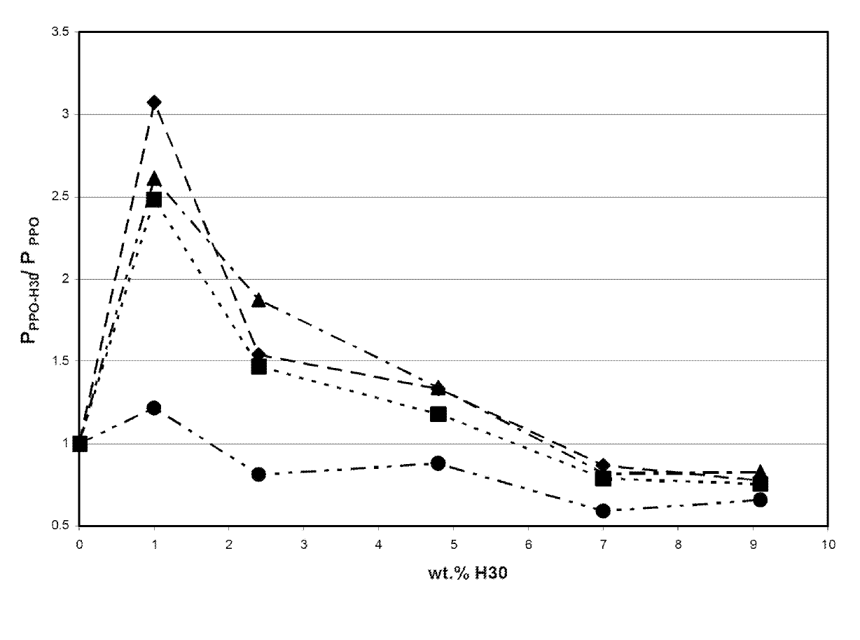

The gas permeation properties of the resulting membranes are measured and a particular maximum was observed of the enhancement at concentration for all gases at very low concentrations. FIG. 1 shows the results for Boltorn H30 at a feed pressure of 1.5 bar (permeate pressure is vacuum; ♦=N₂; ▪=O₂; ▴=CO₂; =He). The graphs for the other generations of the Boltorn dendrimers (H20 and H40) are similar. The selectivity data are shown in Table 2.

TABLE 2

| wt. % H30 | O₂/N₂ | CO₂/N₂ | CO₂/O₂ |
|---|---|---|---|
| 0.0 | 4.33 | 18.69 | 4.32 |
| 1.0 | 3.50 | 15.88 | 4.54 |
| 2.4 | 4.13 | 22.76 | 5.51 |
| 4.8 | 3.93 | 18.78 | 4.90 |
| 7.0 | 3.93 | 17.64 | 4.48 |
| 9.1 | 4.21 | 19.92 | 4.73 |

1. A membrane comprising a polymer composition comprising (a) a (co)polymer comprising an arylene oxide moiety and (b) a dendritic (co)polymer, a hyperbranched (co)polymer or a mixture thereof.

2. The membrane according to claim 1, wherein the polymer composition comprises 0.01 to 10.0 wt. % of the dendritic (co)polymer, the hyperbranched (co)polymer or the mixture thereof, calculated on the total weight of the polymer composition.

3. The membrane according to claim 1, wherein the (co)polymer comprising the arylene oxide moiety has the formula (I): 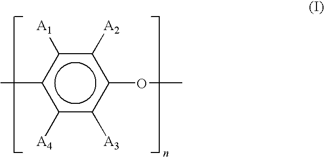
wherein A₁, A₂, A₃ and A₄ are independently selected from the group consisting of hydrogen, linear or branched C₁-C₁₂ alkyl which may optionally be halogenated, C₆-C₁₂ arylalkyl, C₆-C₁₂ alkylaryl, and halogen.

4. The membrane according to claim 1, wherein the dendritic (co)polymer is derived from a central initiator molecule having at least one reactive hydroxy group (A), which hydroxy group (A) under formation of an initial tree structure is bonded to a reactive carboxyl group (B) of a monomeric chain extender holding the two reactive groups (A) and (B), which tree structure is optionally extended and further branched from the initiator molecule by an addition of further molecules of a monomeric chain extender by means of bonding with the reactive groups (A) and (B) thereof, wherein the monomeric chain extender has at least one carboxyl group (B) and at least two hydroxy groups (A) or hydroxyalkyl substituted hydroxyl groups (A).

5. The membrane according to claim 4, wherein the dendritic (co)polymer has the formula (II): 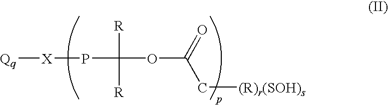
wherein X is O or C;
Q is H or linear or branched C₁-C₆ alkyl;
P is linear or branched C₁-C₆ alkylene;
R is H or linear or branched C₁-C₆ alkyl;
p+q=2 or 4;
if X is O, then q=0 and p=2;
if X is C, then p=2-4, q=0-2, and p+q=4;
S is linear or branched C₁-C₆ alkylene;
r+s=3;
r=0 or 1; and
s=2 or 3.

6. The membrane according to claim 1, wherein the hyperbranched (co)polymer comprises a central nucleus reacted with at least one generation of a monomeric or polymeric branching chain extender and optionally at least one generation of a monomeric or polymeric spacing chain extender, wherein:
(a) the central nucleus prior to the reaction comprises a reactive epoxide group and is selected from the group consisting of:
(i) a glycidyl ester of:
(1) a saturated monofunctional carboxylic acid having 1-24 carbon atoms;
(2) an unsaturated monofunctional carboxylic acid having 3-24 carbon atoms; or;
(3) a saturated or unsaturated di-, tri- or polyfunctional carboxylic acid having 3-24 carbon atoms;
(ii) a glycidyl ether of:
(1) a saturated monofunctional alcohol having 1-24 carbon atoms;
(2) an unsaturated monofunctional alcohol having 2-24 carbon atoms;
(3) a saturated or unsaturated di-, tri- or polyfunctional alcohol having 3-24 carbon atoms;
(4) a phenol or a reaction product thereof;
(5) a condensation product between a phenol and at an aldehyde or an oligomer of such a product;
(iii) a mono-, di- or triglycidyl substituted isocyanurate; and
(iv) an aliphatic, cycloaliphatic or aromatic epoxy polymer;
(b) wherein the branching chain extender comprises three or more reactive sites, one of which being a hydroxy group or a hydroxyalkyl substituted hydroxy group and a carboxy group or terminal epoxide; and
(c) wherein the optional spacing chain extender comprises two or more reactive sites, one of which being a hydroxy group or hydroxyalkyl substituted hydroxy group.

7. The membrane according to claim 4, wherein the dendritic (co)polymer comprise the 1^{st}-6^{th} generation.

8. The membrane according to claim 6, wherein the hyperbranched (co)polymer comprise the 1^{st}-6^{th} generation.

9. The membrane according to claim 4, wherein the dendritic (co)polymer has 12 to 128 hydroxy groups as functional groups.

10. The membrane according to claim 6, wherein the hyperbranched (co)polymer has 12 to 128 hydroxy groups as functional groups.

11. The membrane according to claim 4, wherein the dendritic (co)polymer has a M_{w} of 1000-10000.

12. The membrane according to claim 6, wherein the hyperbranched (co)polymer has a M_{w} of 1000-10000.

13. The membrane according to claim 4, wherein the dendritic (co)polymer has a T_{g} of lower than 80° C.

14. The membrane according to claim 6, wherein the hyperbranched (co)polymer has a T_{g} of lower than 80° C.

15. The membrane according to claim 1, wherein (b) is a dendritic (co)polymer.

16. The membrane according to claim 1, further comprising a support.

17. The membrane according to claim 16, wherein the support is an anisotropic porous support.

18. The membrane according to claim 3, wherein A₂ and A₃ are independently linear or branched C₁-C₄ alkyl and A₁ and A₄ are independently selected from hydrogen, halogen and linear or branched C₁-C₄ alkyl.
